(19) United States
(12) Patent Application Publication
(10) Pub. No.: US 2023/0133117 A1
(43) Pub. Date: May 4, 2023

(54) SERVER AND POWER TRANSACTION SYSTEM

(71) Applicant: TOYOTA JIDOSHA KABUSHIKI KAISHA, Toyota-shi (JP)

(72) Inventors: Yuki KUDO, Kawaguchi-shi (JP); Kazutaka KIMURA, Mishima-shi (JP); Kazuki OBATA, Susono-shi (JP); Hiromitsu KIGURE, Ashigarakami-gun (JP); Satoshi KIKUCHI, Hadano-shi (JP); Yuta MANIWA, Susono-shi (JP)

(73) Assignee: TOYOTA JIDOSHA KABUSHIKI KAISHA, TOYOTA-SHI (JP)

(21) Appl. No.: 17/978,492

(22) Filed: Nov. 1, 2022

(30) Foreign Application Priority Data
Nov. 4, 2021 (JP) 2021-180159

(51) Int. Cl. H02J 3/14; H02J 3/00

(52) U.S. Cl. CPC H02J 3/144; H02J 3/001; H02J 3/004; H02J 2300/20

(57) ABSTRACT

Upon receipt of a reported value (an amount of power generation by a renewable energy facility) in a time slot from an agent of a prosumer (facility), a processor of a transaction market server calculates a predicted amount of power generation of the renewable energy facility in the time slot (S1 to S13). The processor sets a first threshold for the predicted amount of power generation and determines a normal range of the reported value (S15). The processor compares the reported value with the predicted amount of power generation, and when the reported value is outside the normal range, prohibits the facility with the renewable energy facility from using a renewable energy tag.

This nonprovisional application is based on Japanese Patent Application No. 2021 -180159 filed on November 4. 2021 with the Japan Patent Office, the entire contents of which are hereby incorporated by reference.

### BACKGROUND

### Field

The present disclosure relates to a server and a power transaction system.

### Description of the Background Art

Japanese Patent Laying-Open No. 2020-91871 discloses a power transaction history generation system that guarantees traceability of renewable energy power transmitted to a power network. In this power transaction history- generation system, a token corresponding to a supply amount of electric power transmitted to the power network is issued to a supplier’s account in a blockchain. When electric power is supplied from a supplier to a consumer through the power network, a token corresponding to an amount of power transmission is sent to a consumer’s account from the supplier’s account (see Japanese Patent Laying-Open No. 2020-91871).

### SUMMARY

In recent years, the introduction of peer to peer (P2P) power transaction has been considered along with deregulation of electric power. In P2P power transaction, electric power is directly bought and sold between an individual or a corporation and another individual or another corporation, each of which has a power resource, in a power transaction market In the P2P power transaction market, a tag (hereinafter also referred to as “renewable energy tag”) can be attached to electric power generated using renewable energy (hereinafter also referred to as “renewable energy power”) for transactions of renewable energy power.

However, there is a possibility of a fraud of reporting electric power that is not generated using renewable energy (hereinafter also referred to as “non-renewable energy power”) as renewable energy power. A mechanism to suppress such a fraud is desired in the P2P power transaction market.

The present disclosure has been made to solve the above problem. An object of the present disclosure is to suppress a fraud of reporting electric power that is not generated using renewable energy as electric power that is generated using renewable energy.

A server according to an aspect of the present disclosure is a server that manages a power transaction market in which a first prosumer performs a power transaction The first prosumer includes a first power generation facility that generates electric power using renewable energy. The server includes: a memory that stores the first power generation facility registered with the power transaction market; and a processor that allows the first prosumer to bid for the power transaction market with a tag attached to the electric power generated by the first power generation facility, the tag indicating the electric power generated using the renewable energy The processor monitors a first power generation result indicating an amount of power generation of the first power generation facility in a prescribed time slot, and upon detection of an abnormality of the first power generation result, does not accept a bid for the power transaction market from the first prosumer with the tag attached to the electric power generated by the first power generation facility.

With the above configuration, the processor of the server monitors whether there is no abnormality in the amount of power generation (first power generation result) of the first power generation facility. Monitoring the first power generation result can detect an abnormal trend of the first power generation result when a fraud of reporting the non-renewable energy power as renewable energy power is performed. Upon detection of the abnormal trend of the first power generation result, the processor does not accept a bid for the power transaction market with a tag attached to electric power. This can suppress a fraud of reporting non-renewable energy power as renewable energy power

In one embodiment, the memory stores meteorological information and a first power generation capacity of the first power generation facility. The processor calculates a predicted amount of power generation of the first power generation facility based on the meteorological information and the first power generation capacity, and when a discrepancy between the first power generation result and the predicted amount of power generation is not less than a first threshold, detects the abnormality of the first power generation result.

With the above configuration, an abnormal trend of the first power generation result can be detected by monitoring a discrepancy between the first power generation result and the predicted amount of power generation. Upon detection of the abnormal trend of the first power generation result, the processor does not accept a bid for the power transaction market with a tag attached to electric power. This can suppress a fraud of reporting non-renewable energy power as renewable energy power.

In one embodiment, the memory stores a first power generation capacity of the first power generation facility, a second power generation capacity of a second power generation facility of a second prosumer that participates in the power transaction market, and a second power generation result indicating an amount of power generation of the second power generation facility in the prescribed time slot, the second power generation facility generating electric power using renewable energy. The second power generation facility is installed in a same area as that of the first power generation facility. The processor detects the abnormality of the first power generation result when a discrepancy between a first ratio and a second ratio is not less than a second threshold, the first ratio being a ratio between the first power generation result and the first power generation capacity, the second ratio being a ratio between the second power generation result and the second power generation capacity.

With the above configuration, the first power generation facility and the second power generation facility are installed in the same area. Thus, an abnormal trend of the first power generation result can be detected by comparing the ratios between the power generation results and the power generation capacities of both the power generation facilities Upon detection of the abnormal trend of the first power generation result, the processor does not accept a bid for the power transaction market with a tag attached to electric power. This can suppress a fraud of reporting non-renewable energy power as renewable energy power.

In one embodiment, the memory stores a past power generation result of the first power generation facility together with meteorological information associated with the past power generation result The processor calculates a predicted amount of power generation of the first power generation facility in the prescribed time slot from the past power generation result and the meteorological information, and detects the abnormality of the first power generation result when a discrepancy between the first power generation result and the predicted amount of power generation is not less than a third threshold.

With the above configuration, an abnormal trend of the first power generation result can be detected by comparing the first power generation result with the amount of power generation (the predicted amount of power generation) of the first power generation facility, which is predicted from the past power generation result and the meteorological information at that time, in a prescribed time slot. Upon detection of the abnormal trend of the first power generation result, the processor does not accept a bid for the power transaction market with a tag attached to electric power. This can suppress a fraud of reporting non-renewable energy power as renewable energy power.

In one embodiment, the memory stores information indicating a power generation trend of the first power generation facility. The processor detects the abnormality of the first power generation result when an approximate value between a change in an amount of power generation of the first power generation facility and the information indicating the power generation trend is not less than a fourth threshold, the change being derived from a power generation result and the first power generation result, the power generation result indicating an amount of power generation of the first power generation facility in a time slot prior to the prescribed time slot.

With the above configuration, an abnormal trend of the first power generation result can be detected by monitoring an approximate value between a change in the amount of power generation of the first power generation facility and the information indicating a power generation trend. Upon detection of the abnormal trend of the first power generation result, the processor does not accept a bid for the power transaction market with a tag attached to electric power. This can suppress a fraud of reporting non-renewable energy power as renewable energy power.

In one embodiment, upon detection of the abnormality of the first power generation result and upon receipt of a command to lift prohibition on use of the tag, the processor accepts, from the first prosumer, a bid for the power transaction market with the tag attached to the electric power generated by the first power generation facility.

For example, an abnormality of the first power generation result may be detected due to a temporal malfunction of the first power generation facility and/or rapid weather changes. With the above configuration, the processor allows the first prosumer to use a tag again (i.e., the processor accepts a bid with a tag attached to electric power from the first prosumer) as a command to lift the prohibition on the use of the tag is output. For example, a command to lift the prohibition on the use of a tag is output upon checking that there is no fraud . This can suppress unreasonable prohibition on the use of a tag.

A power transaction system according to another aspect of the present disclosure includes a server that manages a power transaction market, and a prosumer that participates in the power transaction market. The prosumer includes a power generation facility that generates electric power using renewable energy. The server stores the power generation facility registered with the power transaction market, and allows the prosumer to bid for the power transaction market with a tag attached to the electric power generated by the power generation facility, the tag indicating the electric power generated using the renewable energy The server monitors a power generation result indicating an amount of power generation of the power generation facility in a prescribed time slot, and upon detection of an abnormality of the power generation result, does not accept a bid for the power transaction market from the prosumer with the tag attached to the electric power generated by the power generation facility.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram for illustrating an example power transaction system according to an embodiment.

FIG. 2. schematically shows an example P2P power transaction market.

FIG. 3 is a diagram for illustrating a bid in a general transaction market for P2P power transaction.

FIG. 4 is a diagram for illustrating an example bid in a direct transaction market for P2P power transaction.

FIG. 5 shows hardware configuration examples of an agent and a transaction market server.

FIG. 6 shows example resource information.

FIG. 7 shows example renewable energy facility information.

FIG. 8 shows example agent information.

FIG. 9 shows example registration information.

FIG. 10 shows example power generation information.

FIG. 11 is a diagram for illustrating detection of a fraudulent use of a renewable energy tag.

FIG. 12 is a block diagram functionally showing a configuration regarding detection of a fraudulent use of a renewable energy tag in a transaction market server.

FIG. 13 is a flowchart showing a procedure of a process regarding whether a renewable energy tag can be used.

FIG. 14 is a flowchart showing a procedure of a process regarding whether a renewable energy tag can be used according to Variation 1.

FIG. 15 is a flowchart showing a procedure of a process regarding whether a renewable energy tag can be used according to Variation 2.

FIG. 16 is a flowchart showing a procedure of a process regarding whether a renewable energy tag can be used according to Variation 3.

### DESCRIPTION OF THE PREFERRED EMBODIMENTS

Embodiments of the present disclosure will now be described with reference to the drawings The same or corresponding elements in the drawings have the same reference characters allotted, and description thereof will not be repeated.

### Configuration of Power Transaction System

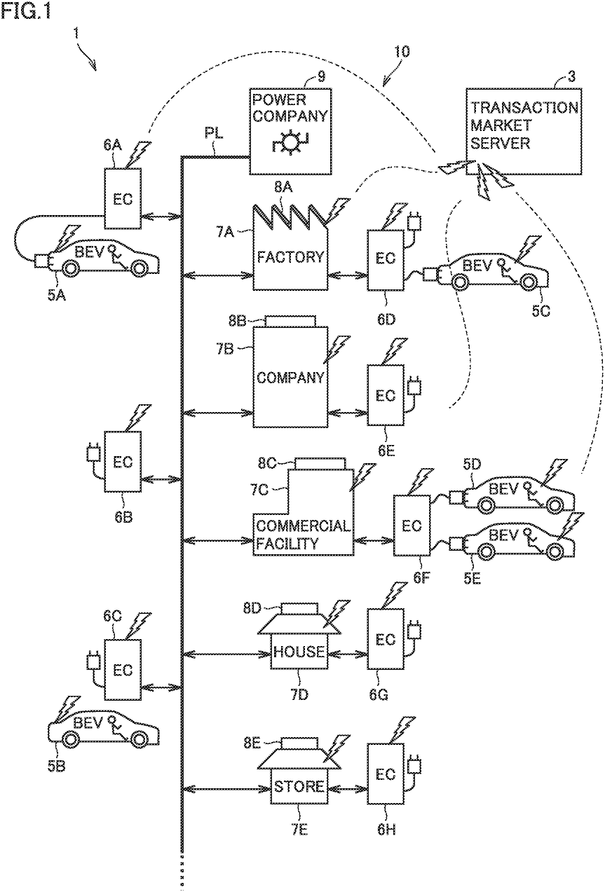

FIG. 1 is a diagram for illustrating an example of a power transaction system 1 according to the present embodiment. Referring to FIG. 1, power transaction system 1 includes a transaction market server 3, electric-powered vehicles 5A to 5E, charging and discharging facilities 6A to 6H, a factory 7A, a company 7B, a commercial facility 7C, a house 7D, a store 7E, a power company 9, a power transmission line network PL, and a communication network 10. Electric-powered vehicles 5A to 5E, factory 7A, company 7B, commercial facility 7C, house 7D, and store 7E are electric power resources in power transaction system 1 and serve as so-called prosumers. Each electric power resource is configured to transfer electric power to and from another electric power resource through power transmission line network PL or directly.

The number of electric-powered vehicles and the number of charging and discharging facilities are not limited to the numbers shown in FIG. 1. Also, the facility such as factory 7A is not limited to a facility shown in FIG. 1. Each of electric-powered vehicles 5A to 5E may be referred to as “electric-powered vehicle 5” below without distinction. Each of charging and discharging facilities 6A to 6H may also be referred to as “charging and discharging facility 6” without distinction. Each of factory 7A, company 7B, commercial facility 7C, house 7D, and store 7E may also be referred to as “facility 7” without distinction.

Electric-powered vehicle 5 can travel using electric power stored in a battery. Electric-powered vehicle 5 is electrically connected to charging and discharging facility 6 and is configured to perform charging and discharging of the battery via charging and discharging facility 6. Electric-powered vehicle 5 may be, for example, a battery electric vehicle (BEV) or a plug-in hybrid electric vehicle (PHEV) FIG. 1 shows an example in which electric-powered vehicle 5 is a BEV. Electric-powered vehicle 5 is electrically connectable to charging and discharging facility 6 and can transfer electric power to and from power transmission line network PL or facility 7 via charging and discharging facility 6.

Facility 7 is electrically connected to power transmission line network PL and can transfer electric power to and from power transmission line network PL. Also, facility 7 is electrically connected to charging and discharging facility 6 and can transfer electric power to and from electric-powered vehicle 5 connected to charging and discharging facility 6. facility 7 includes a battery that stores electric power and is configured to perform charging and discharging of a battery via power transmission line network PL or charging and discharging facility 6.

Facility 7 further includes a solar power generation device (also referred to as solar photovoltaics (PV) below) 8. Specifically, factory 7A is equipped with a PV 8A, company 7B is equipped with a PV 8B, commercial facility 7C is equipped with a PV 8C, house 7D is equipped with a PV 8D, and store 7E is equipped with a PV 8E. PV 8 is a device that generates electric power using sunlight, which is one type of renewable energy. PV 8 includes a solar panel that generates electric power owing to the photoelectric effect, an inverter that boosts a voltage of the electric power generated by the solar panel, and the like. In place of, or in addition to, PV 8, a power generation device that generates electric power using renewable energy (e.g , wind power, thermal power, biomass) other than sunlight may be provided in facility 7. FIG. 1 shows an example in which PV 8 is installed on the roof of facility 7 However, PV 8 may be installed on the ground within the site of facility 7, and an installation manner is not particularly limited. Electric power generated in PV 8 can be supplied to a power consumer through power transmission line network PL or charging and discharging facility 6.

Charging and discharging facility 6 is electrically connected to power transmission line network PL or facility 7. Charging and discharging facility 6 includes a power cable. Charging and discharging facility 6 is electrically connectable to electric-powered vehicle 5 via the power cable, and electric-powered vehicle 5 can transfer electric power to and from power transmission line network PL or facility 7 via charging and discharging facility 6 that is a connection destination.

Power company 9 manages a power plant (not shown). Electric power generated in the power plant is supplied to each facility 7 through power transmission line network PL (system power grid) and can also be supplied to electric-powered vehicle 5A connected to charging and discharging facilities 6A to 6C.

Conventionally, electric power has been supplied to facility 7 or electric-powered vehicle 5 through power transmission line network PL from the power plant of power company 9. With deregulation of electric power and spread of power generation technologies for renewable energy in recent years, power purchase and sale transactions have been considered not only with power company 9 but also between individuals or companies with electric power resources. In power transaction system 1 according to the present embodiment, power purchase and sale transactions between individuals or companies (facilities 7 or electric-powered vehicles 5), that is, peer to peer (P2P) power transactions can be performed.

Transaction market server 3 provides a platform for conducting P2P power transactions Transaction market server 3 is configured to communicate with electric-powered vehicle 5, charging and discharging facility 6, and facility 7 over communication network 10. Though described below in detail, a plurality of power transaction markets are formed in transaction market server 3. When facility 7 or electric-powered vehicle 5 desires P2P power transaction, facility 7 or electric-powered vehicle 5 (specifically, an agent that conducts a power transaction by facility 7 or electric-powered vehicle 5 (which will be described below)) designates a power transaction market where a power transaction is desired, and then, bids for transaction market server 3, for example, with a time slot in which selling or buying of electric power is desired, an amount of electric power sold or bought for each unit time slot, a transaction price, and the like as bid conditions. Transaction market server 3 puts a contract for power transaction into effect between a seller and a buyer with matching bid conditions based on any algorithm, and processes, as an unsuccessful bid, a bid without a partner with matching conditions, The “bid” means an act of placing an order for power transaction (buy or sell) or the order itself. The “contract” means an act of determining to conduct a power transaction for which the bid was made or the determination itself

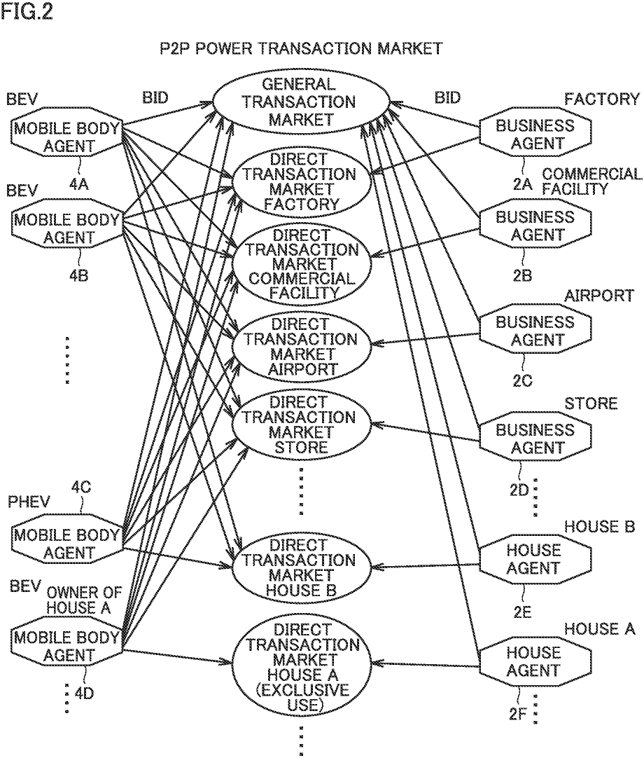

FIG. 2 schematically shows an example of the P2P power transaction market. Referring to FIG. 2, in the P2P power transaction market, the “agent” that bids for the P2P power transaction market plans and conducts a bid, manages a contract, creates a charging and discharging plan based on the contract, and the like The agent is provided for each facility 7 or each electric-powered vehicle 5. In the present embodiment, there are mobile body agents 4A to 4D corresponding to respective electric-powered vehicles 5, business agents 2A to 2D corresponding to factory 7A and the like, and house agents 2E, 2F corresponding to the respective houses For example, in the case of electric-powered vehicle 5, the mobile body agent of electric-powered vehicle 5 creates a power transaction plan (bid plan) for the P2P power transaction market, and this mobile body agent bids for the P2P power transaction market (transaction market server 3). In the case of house 7D, the house agent of house 7D creates a power transaction plan (bid plan) to the P2P power transaction market, and this house agent bids for the P2P power transaction market (transaction market server 3).

Each of the agents of facilities 7, that is, business agents 2A to 2D and house agents 2E, 2F may be referred to as “agent 2” below without distinction. Also, each of mobile body agents 4A to 4D corresponding to respective electric-powered vehicles 5 may be referred to as “agent 4” without distinction.

The P2P power transaction market includes a “general transaction market” and a “direct transaction market.” In the present embodiment, the general transaction market and the direct transaction market are formed in transaction market server 3, The general transaction market is a market that handles transactions of electric power transmitted through power transmission line network PL, and a large number of unspecified agents 2, 4 can participate in power transactions In the general transaction market, a power transaction is contracted according to any rules determined by an operator that manages the P2P power transaction market (matching). The matching rules include, for example, a method of completing a contract on a first-come-first-served basis when a price presented by a seller matches with a price presented by a buyer in a prescribed unit time slot In any other matching rule, bids (orders) from sellers and buyers conducted in a unit time slot can be organized, and then, a transaction can be completed at an appropriate price

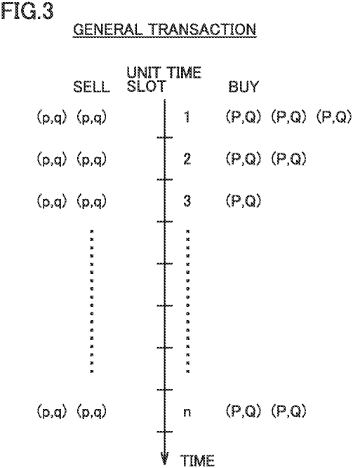

FIG. 3 illustrates an example bid in the general transaction market for P2P power transaction. Referring to FIG. 3, in the general transaction market, each of a large number of unspecified sellers bids a set (p, q) of a selling price and an amount of electric power while each of a large number of unspecified buyers bids a set (P, Q) of a buying price and an amount of electric power, per prescribed unit time slot (1,2,...,n). The unit time slot is a time frame (e.g., 30 minutes) set in the general transaction market. Transaction of the amount of electric power is conducted for each amount of electric power transmitted in the unit time slot (electric power x duration of unit time slot).

Referring again to FIG. 2. the direct transaction market is a market that handles transactions of electric power transmitted not through power transmission line network PL by electric-powered vehicle 5 moving to a location of facility 7, and only an agent having an ID for the direct transaction market can participate in power transactions. In the direct transaction market, one market is formed for facility 7 where charging and discharging facility 6 is installed In the direct transaction market, a power transaction is contracted according to any rules determined independently by an operator of each market (matching). The method described above in connection with the general transaction market is adoptable as the matching rules. Although transaction market server 3 manages the general transaction market and the direct transaction market according to the matching rules for each P2P power transaction market (general transaction market and direct transaction market) in the present embodiment, a server corresponding to transaction market server 3 may be provided for each P2P power transaction market.

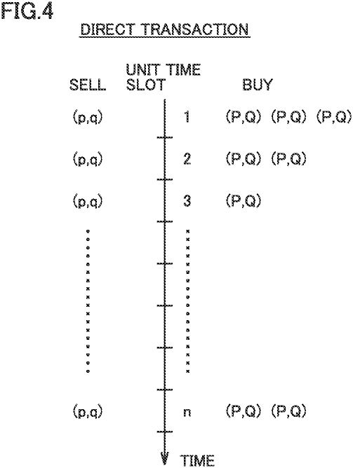

FIG. 4 illustrates an example bid in the direct transaction market for P2P power transaction. Referring to FIG. 4, in the direct transaction market, in response to a seller presenting a set (p, q) of a selling price and an amount of electric power, each of a plurality of buyers, having respective IDs for the direct transaction market, bids a set (P, Q) of a buying price and an amount of electric power, per prescribed unit time slot (1,2,...,n). The unit time slot is a time frame individually set in the direct transaction market. Transaction of the amount of electric power is conducted for each amount of electric power transmitted in the unit time slot (electric power × duration of unit time slot).

Referring again to FIG. 1, the P2P power transaction market according to the present embodiment allows facility 7 with a power generation facility (hereinafter also referred to as “renewable energy facility”), which generates electric power using renewable energy, to make a bid with a tag (hereinafter also referred to as “renewable energy tag”) provided to electric power (renewable energy power) generated in a renewable energy facility, the tag indicating renewable energy power. The use of the renewable energy tag allows for distinction between renewable energy power and nonrenewable energy power in P2P power transactions. This enables transactions of renewable energy power in the P2P power transaction market.

In participating as a prosumer in the P2P power transaction market, facility 7 submits an apply for participation to the administrator of transaction market server 3 In this application for participation, facility 7 can register a power generation facility (renewable energy facility) that generates electric power using renewable energy with the administrator of transaction market server 3. The renewable energy facility is PV 8 in the present embodiment. Upon registration of the renewable energy facility, facility 7 can provide a renewable energy tag to electric power generated in the renewable energy facility and conduct transactions of the electric power with the renewable energy tag as renewable energy power in the P2P power transaction market In other words, transaction market server 3 accepts a bid using a renewable energy tag from facility 7 (agent 2) that has registered a renewable energy facility In registration of the renewable energy facility, for example, a renewable energy facility, which is a registration target, is checked on site by an administrator of the P2P power transaction market (e g., an employee of a management company)

There is a possibility of a fraud of reporting electric power that is not generated using renewable energy (non-renewable energy power) as renewable energy power. For example, it is assumed here that PV 8 is registered as a renewable energy facility when a facility 7 participates in the P2P power transaction market . Facility 7 may then fraudulently install a power generation facility, which is not a renewable energy facility, such as a diesel generator, attach a renewable energy tag to electric power generated by this power generation facility, and conduct a transaction in the P2P power transaction market The P2P power transaction market is desired to have a mechanism to detect such a fraud.

Thus, for facility 7 that has registered a renewable energy facility (i.e., facility 7 that uses a renewable energy tag), transaction market server 3 according to the present embodiment monitors an amount of power generation of a registered renewable energy facility. Specifically, transaction market server 3 obtains a reported value indicating an amount of power generation of the registered renewable energy facility for each unit time slot (described below) from agent 2 of facility 7. Transaction market server 3 then predicts an amount of power generation of the registered renewable energy facility for each time slot from meteorological information on an area including a location of facility 7 and a power generation capacity of the registered renewable energy facility. Transaction market server 3 compares the predicted amount of power generation with the reported value, and when a discrepancy therebetween is not less than a first threshold, prohibits facility 7 with the renewable energy facility from using the renewable energy tag. This allows for detection of an abnormal trend in the reported value, enabling detection of a fraud of reporting non-renewable energy power as renewable energy power The reported value according to the present embodiment corresponds to an example of the “first power generation result” according to the present disclosure.

For facility 7 that has been prohibited from using the renewable energy tag, the renewable energy facility is checked on site in facility 7 by an administrator of transaction market server 3 (e.g , an employee of a management company) . When the administrator of transaction market server 3 checks that no fraud has been conducted on the registered renewable energy facility of facility 7, facility 7 that has been prohibited from using the renewable energy tag can use the renewable energy tag again. For example, an abnormality of the reported value may be detected due to a temporal malfunction of a renewable energy facility and/or rapid weather changes. In such a case, the use of the renewable energy tag is enabled again by checking a renewable energy facility on site, thus suppressing unreasonable prohibition on the use of a renewable energy tag.

### Hardware Configuration

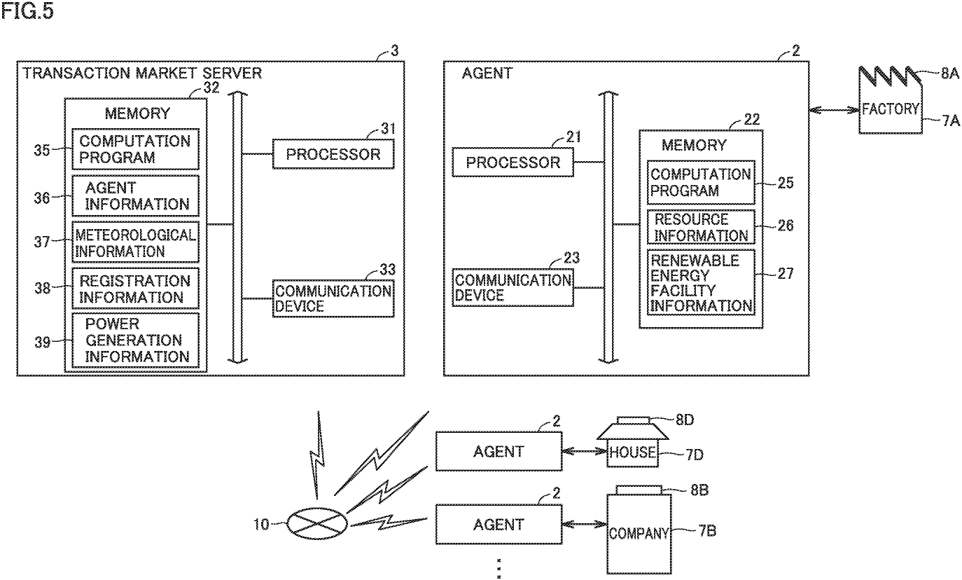

FIG. 5 shows hardware configuration examples of agent 2 and transaction market server 3. Referring to FIG. 5, agent 2 includes a processor 21, a memory 22, and a communication device 23. Agent 2 is provided for each facility 7 (prosumer). Agent 2 may be provided in its corresponding prosumer or may be provided in a cloud that can communicate with its corresponding prosumer.

Processor 21 is a computation entity (computer) that executes various programs to perform various types of processing. Processor 21 is implemented by a central processing unit (CPU), a field-programmable gate array (FPGA), a graphics processing unit (GPU), or the like. Processor 21 may be implemented by processing circuitry.

Memory 22 stores a program and data for processor 21 to perform various types of processing. Memory 22 is implemented by a storage medium such as a read only memory (ROM) and a random access memory (RAM) Memory 22 stores a computation program 25, resource information 26, and renewable energy facility information 27.

Computation program 25 specifies processing performed by processor 21. For example, computation program 25 includes a program for executing, to transaction market server 3, a bid for power transaction in the P2P power transaction market managed by transaction market server 3.

Resource information 26 includes information on a prosumer (e.g., factory 7A) corresponding to agent 2, and particularly, includes information on a bid and a contract for power transaction.

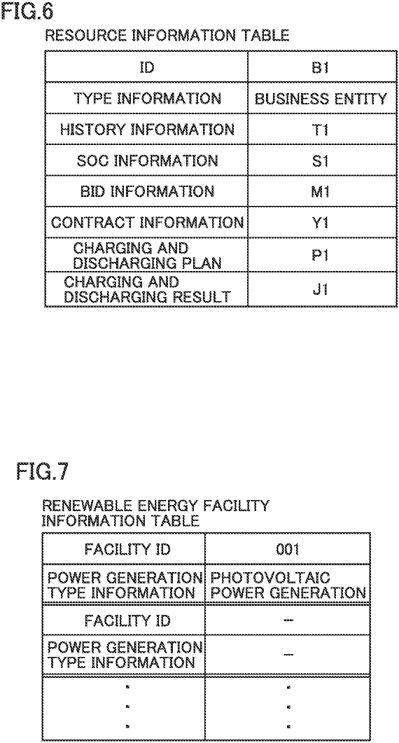

FIG. 6 illustrates an example of resource information 26 FIG. 6 shows resource information 26 in agent 2 (business agent) of factory 7A by way of example. Referring to FIG. 6, resource information 26 includes an ID, type information, history information, state of charge (SOC) information, bid information, contract information, a charging and discharging plan, and a charging and discharging result.

The ID includes identification information for specifying a prosumer (factory 7A in this example). The type information includes information on a prosumer type. The information on the prosumer type includes, for example, information for specifying a business entity, a house, or the like. The history information includes information on history of past power use by a prosumer. The information on user history may be divided, for example, per day or time slot. The SOC information includes information on an amount of electric power (amount of power storage) currently stored in a battery of the prosumer The bid information includes information on history of the past bids and information on a bid currently contracted. The contract information includes information on history of the past contracts, and information for specifying whether a currently conducted bid has completed. The charging and discharging plan includes information on a charging and discharging plan of a prosumer based on a contract. The charging and discharging result includes information on a result of charging and discharging for the charging and discharging plan.

FIG. 7 shows an example of renewable energy facility information 27 FIG. 7 shows renewable energy facility information 27 in agent 2 (business agent) of factory 7A by way of example. Referring to FIG. 7, renewable energy facility information 27 includes a facility ID and power generation type information

The facility ID is an ID for managing a renewable energy facility of facility 7. Shown here is an example in which ID: 001 is assigned to PV 8A of factory 7A. The facility ID may be, for example, a manufacturing number attached in shipment of a facility. The type of renewable energy used by a renewable energy facility for power generation is registered with the power generation type information. For example, “photovoltaic power generation”, “wind power generation”, “geothermal power generation”, “biomass power generation”, and any other power generation are registered with the power generation type information. PV 8A is a device capable of photovoltaic power generation, and accordingly, information on “photovoltaic power generation” is stored as the power generation type information. When factory 7A has a renewable energy facility in addition to PV 8A, information on the other renewable energy facility is stored in renewable energy facility information 27, similarly to PV 8A.

Referring again to FIG. 5, communication device 23 transmits and receives various types of data to and from transaction market server 3 over communication network 10.

Transaction market server 3 includes a processor 31, a memory 32, and a communication device 33. Transaction market server 3 is a device that manages P2P power transaction between the prosumers in the P2P power transaction market (general transaction market and direct transaction market), and performs power transaction processing.

Processor 31 is a computation entity (computer) that executes various programs to perform various types of processing Processor 31 is implemented by CPU, FPGA, GPU, or the like. Processor 31 may be implemented by processing circuitry.

Memory 32 stores a program and data for processor 31 to perform various types of processing. Memory 32 is implemented by a storage medium such as ROM and RAM. Memory 32 stores computation program 35, agent information 36, meteorological information 37, registration information 38, and power generation information 39.

Computation program 35 specifies processing performed by processor 31. For example, computation program 35 includes a program for performing bid processing of accepting bids from agents 2, 4 and contract processing based on the bid. In the contract processing, a contract is concluded for power transaction between a seller and a buyer with matching bid conditions, and for a bid without a partner with matching conditions, such a bid is handled as an unsuccessful bid.

Agent information 36 includes information on agent 2 and agent 4 participating in the P2P power transaction market managed by transaction market server 3, and particularly, includes information on a bid and a contract for power transaction for each agent 2 and for each agent 4.

FIG. 8 shows an example of agent information 36. Referring to FIG. 8, agent information 36 includes an ID, type information, bid information, and contract information.

The ID includes identification information for specifying an agent (agent 2 or agent 4) participating in the P2P power transaction market managed by transaction market server 3. The type information includes information on a prosumer type, and for example, includes information for specifying an electric-powered vehicle, a business entity, a house, or the like. The bid information includes information on history of the past bids in each agent (agent 2 or agent 4) and information on a bid currently conducted The contract information includes information on history of the past contracts in each agent (agent 2 or agent 4) and information for specifying whether a bid currently conducted has been concluded.

Referring again to FIG. 5, meteorological information 37 includes information on an amount of solar radiation, weather, an atmospheric temperature, a velocity of the wind, or the like per area. The information on an amount of solar radiation, weather, an atmospheric temperature, a velocity of the wind, or the like may be divided for each prescribed period of time (e.g., 30 minutes or one hour). For example, processor 31 may obtain meteorological information 37 regularly from an external server device (not shown) via communication device 33.

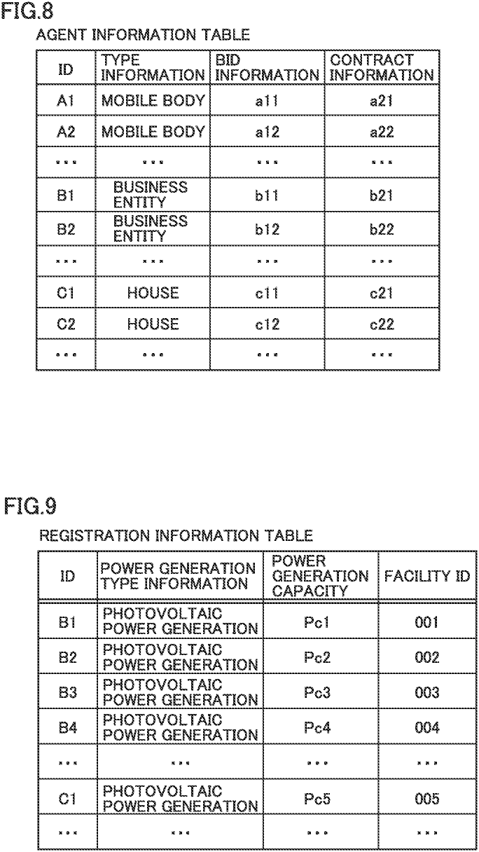

Registration information 38 includes information on a renewable energy facility registered with the P2P power transaction market FIG. 9 shows an example of registration information 38. Referring to FIG. 9, registration information 38 includes an ID, power generation type information, a power generation capacity, and a facility ID Registration information 38 is updated as a renewable energy facility is newly registered with the P2P power transaction market.

The ID includes identification information for specifying a prosumer (herein, facility 7). This ID is similar to the ID of resource information 26. The power generation type information includes information for specifying the power generation type of a registered renewable energy facility. The present embodiment shows and describes an example in which each facility 7 includes PV 8, and accordingly, information indicating “photovoltaic power generation” is stored in the power generation type information of each facility 7. The power generation capacity is a specification value indicating an output capacity of a registered renewable energy facility The unit used for power generation capacity may be, for example, “kW”. The facility ID is an ID for managing a renewable energy facility and is similar to, for example, the facility ID of renewable energy facility information 27.

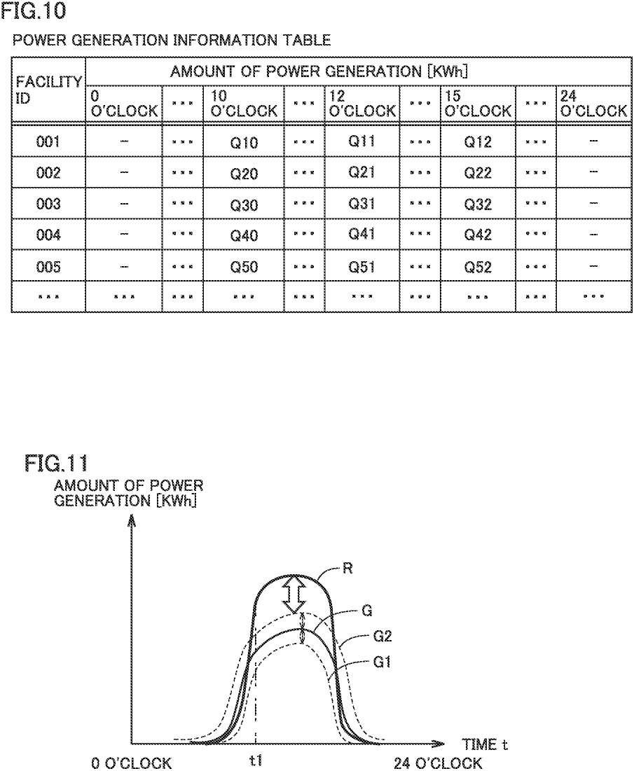

Referring again to FIG. 5. power generation information 39 is information in which an amount of power generation (reported value) “kWh” reported from each electric power resource is recorded by time slot. FIG. 10 shows an example of power generation information 39. Referring to FIG. 10, power generation information 39 includes infonnation indicating a facility ID and information indicating an amount of power generation per time slot Power generation information 39 is stored daily. In FIG. 10, a day is divided hourly, and a unit time slot is set to one hour. However, the unit time slot can be set as appropriate For example, the unit time slot may be less than one hour (e g., 30 minutes) or not less than one hour (e.g., two hours). The unit time slot according to the present embodiment corresponds to an example of the “prescribed time slot” according to the present disclosure.

For example, PV 8A specified by the facility ID indicating 001, that is, PV 8A installed in factory 7A generates electric power of Q10 “kWh” at 10 o‘clock, generates electric power of Q11 “kWh” at 12 o‘clock, and generates electric power of Q12 “kWh” at 15 o‘clock. These pieces of information are reported from factory 7A to transaction market server 3 via agent 2A.

Transaction market server 3 monitors a reported value of an amount of power generation from each facility 7 (each prosumer). A specific monitoring technique will be described using PV 8A of factory 7A by way of example. Upon receipt of the reported value, transaction market server 3 specifies a time slot corresponding to the reported value and reads meteorological information 37 corresponding to this time slot from memory 32. The time slot corresponding to the reported value will also be referred to as a “corresponding time slot” below.

Transaction market server 3 uses meteorological information 37 to specify an amount of solar radiation in an area where factory 7A is located in the corresponding time slot. Transaction market server 3 then predicts an amount of power generation of PV 8A in the corresponding time slot based on the specified amount of solar radiation and the power generation capacity of PV 8A. The amount of power generation of PV 8, predicted by transaction market server 3, will also be referred to as a “predicted amount of power generation” below.

Transaction market server 3 compares the reported value of the amount of power generation from PV 8A with the predicted amount of power generation, and when a discrepancy therebetween is not less than the first threshold, determines a possibility of fraudulent use of the renewable energy tag and prohibits facility 7 with the relevant renewable energy facility from using the renewable energy tag.

FIG. 11 is a diagram for illustrating detection of a fraudulent use of a renewable energy tag. In FIG. 11, the horizontal axis indicates a time, and the vertical axis indicates an amount of power generation A solid line R shown in FIG. 11 indicates a reported value from PV 8A. A solid line G indicates a predicted amount of power generation of PV 8 which is predicted based on the amount of solar radiation and the power generation capacity of PV 8A.

Transaction market server 3 sets a predicted amount of power generation, and then, determines a range in which a discrepancy from the predicted amount of power generation is within the first threshold as a normal range. In other words, transaction market server 3 sets a lower limit and an upper limit for determining that a reported value is normal. In FIG. 11, a broken line G1 indicates the lower limit, and a broken line G2 indicates an upper limit. The magnitude of discrepancy between solid line G and broken line G1 and the magnitude of discrepancy between solid line G and broken line G2 are equal to the first threshold.

The first threshold is determined based on an experimental result using a renewable energy facility (experimental facility) installed in a certain area for an experiment. For example, transaction market server 3 predicts an amount of power generation of the experimental facility from a power generation capacity of the experimental facility and the meteorological information on the area where the experimental facility is installed. Transaction market server 3 then obtains a difference value between the predicted amount of power generation and the actual amount of power generation, and adds a certain margin to the difference value, thereby determining the first threshold, The first threshold may be determined, for example, for each area (an area where a renewable energy facility is installed) in which the location of facility 7 is included, each power generation type of the renewable energy facility, and/or each power generation capacity of the renewable energy facility. For example, the first threshold can be mapped with the area where the renewable energy facility is installed, the power generation type of the renewable energy facility, and the power generation capacity of the renewable energy facility as parameters. The map can be stored, for example, in memory 32. Transaction market server 3 may determine the first threshold based on a simulation result of the amount of power generation performed for each area where the renewable energy facility is installed, each power generation type of the renewable energy facility, and each power generation capacity of the renewable energy facility. For example, transaction market server 3 may learn a difference between the predicted amount of power generation and the actual amount of power generation (reported value) by the renewable energy facility, and add a certain margin to the difference value obtained through learning, thereby determining the first threshold.

In the example shown in FIG. 11, for example, it is assumed that agent 2 output a reported value to transaction market server 3 at time t1. At time t1, a reported value R from PV 8A is more than upper limit G2 of predicted amount of power generation G When determining that reported value R is more than upper limit G2 at time t1. transaction market server 3 prohibits factory 7A with PV 8A from using a renewable energy tag. Factory 7A can continuously perform a power transaction that does not use a renewable energy tag,

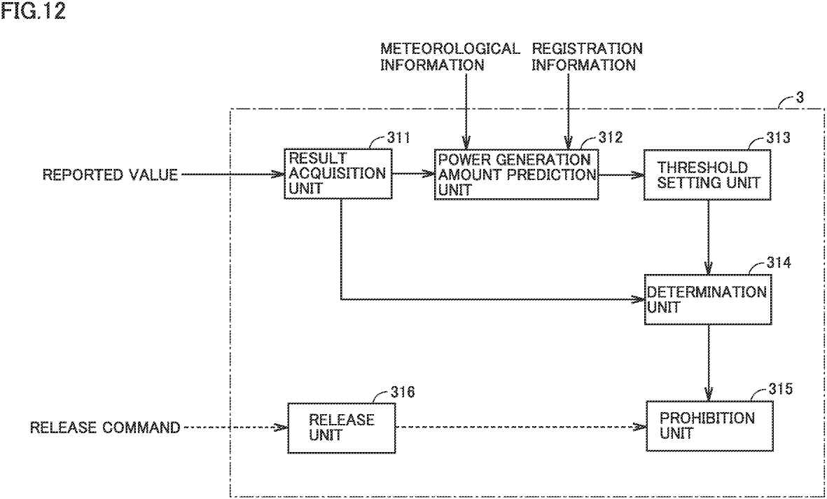

FIG. 12 is a block diagram functionally showing a configuration regarding detection of a fraudulent use of a renewable energy tag in transaction market server 3. Transaction market server 3 includes a result acquisition unit 311, a power generation amount prediction unit 312, a threshold setting unit 313, a determination unit 314, a prohibition unit 315, and a release unit 316. Processor 31 functions as result acquisition unit 311, power generation amount prediction unit 312, threshold setting unit 313, determination unit 314, prohibition unit 315, and release unit 316 by, for example, executing computation program 35 stored in memory 32. Result acquisition unit 311, power generation amount prediction unit 312, threshold setting unit 313, determination unit 314, prohibition unit 315, and release unit 316 may be implemented by, for example, dedicated hardware (electronic, circuitry).

Result acquisition unit 311 obtains an amount of power generation (reported value) of a registered renewable energy facility from agent 2 of facility 7. For example, result acquisition unit 311 obtains a reported value from agent 2 for each unit time slot. Agent 2 attaches the facility ID to the reported value based on renewable energy facility information 27 in order to specify to which renewable energy facility the reported value belongs. When obtaining the reported value attached with the facility ID, result acquisition unit 311 outputs the facility ID to power generation amount prediction unit 312 and outputs the reported value to determination unit 314.

Power generation amount prediction unit 312 reads registration infonnation 38 from memory 32, and queries registration information 38 for the facility ID received from result acquisition unit 311. thus specifying to which renewable energy facility the reported value belongs. Power generation amount prediction unit 312 then reads the power generation type information and the power generation capacity of the specified renewable energy facility from registration information 38 Power generation amount prediction unit 312 also specifies, from registration information 38, an ID associated with a facility ID, that is, an ID of facility 7 with a renewable energy facility specified by this facility ID. Power generation amount prediction unit 312 specifies facility 7 using the ID, and reads, from memory 32, meteorological information 37 on an area including a location of the specified facility 7 The read meteorological information 37 belongs to a corresponding time slot. Power generation amount prediction unit 312 then selects appropriate information corresponding to a power generation type of the specified renewable energy facility from among pieces of infonnation included in meteorological information 37 When the power generation type is photovoltaic power generation, for example, power generation amount prediction unit 312 selects information on an amount of solar radiation. When the power generation type is a wind power generation facility, for example, power generation amount prediction unit 312 selects information on the velocity of the wind and the direction of the wind Power generation amount prediction unit 312 calculates a predicted amount of power generation of a renewable energy facility based on the selected meteorological information 37 and the power generation capacity. Power generation amount prediction unit 312 outputs the calculated predicted amount of power generation to threshold setting unit 311,

Threshold setting unit 313 sets the first threshold (lower limit and upper limit) for the predicted amount of power generation. Threshold setting unit 313 reads a map from memory 32 and queries the map for the area where the renewable energy facility is installed (an area including a location of facility 7), the power generation type of the renewable energy facility, and the power generation capacity of the renewable energy facility, thereby setting the first threshold. As the first threshold is set, the normal range of the reported value is determined from the predicted amount of power generation and the first threshold. Threshold setting unit 313 outputs the predicted amount of power generation and the set first threshold to determination unit 314.

Determination unit 314 determines whether a discrepancy between the reported value and the predicted amount of power generation is within the first threshold. Specifically, determination unit 314 compares the reported value with the predicted amount of power generation and determines whether a difference therebetween is within the first threshold. When the difference therebetween is within the first threshold, that is, when the reported value is within the normal range, determination unit 314 determines that the renewable energy tag is not used fraudulently and that the renewable energy tag is being used appropriately. When the difference therebetween is not within the first threshold, that is, when the reported value is outside the normal range, determination unit 314 determines that the renewable energy tag may not be used appropriately (a possibility of fraudulent use). Determination unit 314 outputs a determination result to prohibition unit 315.

When receiving a determination result indicating the possibility of a fraudulent use of the renewable energy tag, prohibition unit 315 prohibits facility 7 with the renewable energy facility from using a renewable energy tag. When the use of the renewable energy tag is prohibited, even if there is a bid (sell bid) with the renewable energy tag from facility 7 (agent 2) that has been prohibited from using the renewable energy tag, transaction market server 3 does not accept this bid in subsequent P2P power transactions. Transaction market server 3 continuously accepts a bid without a renewable energy tag from facility 7 (agent 2) that has been prohibited from using the renewable energy tag

Upon detection that a release operation has been performed, release unit 316 lifts the prohibition on the use of the renewable energy tag which has been prohibited by prohibition unit 315. The administrator of transaction market server 3 (e.g., an employee of a management company) goes to facility 7 that has been prohibited from using the renewable energy tag, and checks the renewable energy facility, which results in the prohibition on the use of the renewable energy tag, on site. When checking that no fraud has been conducted on the renewable energy facility through checking on site, the administrator performs a release operation for transaction market server 3 or for a terminal of the administrator. Upon detection that the release operation has been performed, release unit 316 outputs a command to lift the prohibition on the use of the renewable energy tag to prohibition unit 315. In response to this command, prohibition unit 315 lifts the prohibition on the use of the renewable energy tag. Thus, facility 7 that has been prohibited from using the renewable energy tag can again bid for the P2P power transaction market using the renewable energy tag.

### Flowchart

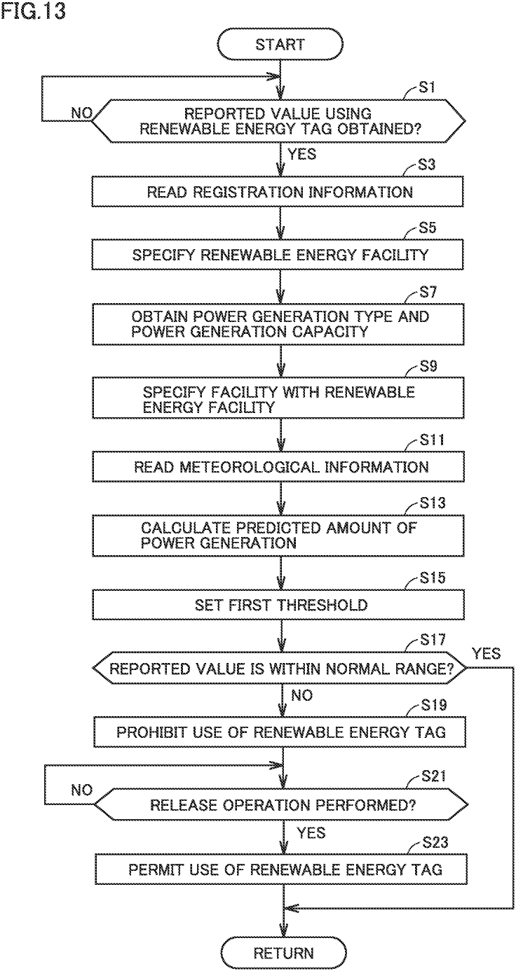

FIG. 13 is a flowchart showing a procedure of a process regarding whether a renewable energy tag can be used. The process of this flowchart starts together with the start of transaction market server 3 and is performed by processor 31. Each step of the flowchart will be abbreviated as “S” below.

In S1, processor 31 determines whether it has received, from agent 2, an amount of power generation (reported value) by a registered renewable energy facility in a time slot. When determining that it has not received a reported value (NO in S1), processor 31 waits for the reception of a reported value. When determining that it has received a reported value (YES in S1), processor 31 moves the process to S3 To the reported value, a facility ID of a renewable energy facility corresponding to the reported value is attached by agent 2.

In S3, processor 31 reads registration information 38 from memory 32. Processor 31 then moves the process to S5.

In S5. processor 31 inquires registration information 38 for the facility ID attached to the reported value to specify to which renewable energy facility the reported value belongs.

In S7, processor 31 reads the power generation type information and the power generation capacity of the specified renewable energy facility from registration information 38.

In S9, processor 31 specifies facility 7 with the renewable energy facility using the ID associated with the specified renewable energy facility. As facility 7 is specified, a location of facility 7, that is, an area where a renewable energy facility is installed can be specified.

In S11, processor 31 reads, from memory 32, meteorological information 37 on an area including the location of the specified facility 7. When meteorological information 37 is divided for each prescribed period of time, meteorological information 37 read in S11 relates to the period of time corresponding to the corresponding time slot.

In S13, processor 31 selects appropriate information corresponding to the power generation type of the specified renewable energy facility from among pieces of information included in meteorological information 37. Processor 31 then calculates a predicted amount of power generation of the renewable energy facility based on the selected meteorological information 37 and the power generation capacity.

In S15, processor 31 sets a first threshold (a lower limit and an upper limit) for the predicted amount of power generation. For example, processor 31 reads a map from memory 32 and queries the map for the area where the renewable energy facility is installed (the area including the location of facility 7), the power generation type of the renewable energy facility, and the power generation capacity of the renewable energy facility, thus setting the first threshold.

In S17, processor 31 determines whether a discrepancy between the reported value and the predicted amount of power generation is within the first threshold, that is, whether the reported value is within the normal range. When the discrepancy between the reported value and the predicted amount of power generation is within the first threshold, that is, when the reported value is within the normal range (YES in S17), processor 31 determines that the renewable energy facility will be used legitimately and moves the process to RETURN. When the discrepancy between the reported value and the predicted amount of power generation is not within the first threshold, that is, when the reported value is outside the normal range (NO in S17), processor 31 moves the process to S19.

In S19, processor 31 prohibits facility 7 with the renewable energy facility from using the renewable energy tag because the renewable energy tag may be fraudulently used. In other words, even when the relevant facility 7 makes a bid with a renewable energy tag attached to electric power, processor 31 does not accept this bid. This prevents the relevant facility 7 from bidding for the P2P power transaction market using the renewable energy tag.

In S21, processor 31 determines whether a release operation has been performed. When determining that the release operation has not been performed (NO in S21), processor 31 continuously prohibits the use of the renewable energy tag. When determining that the release operation has been performed (YES in S21), processor 31 moves the process to S23.

In S23, processor 31 lifts the prohibition on the use of the renewable energy tag and allows facility 7 with the renewable energy facility to use the renewable energy tag In other words, processor 31 accepts a bid attached with the renewable energy tag from facility 7.

As described above, in power transaction system 1 according to the present embodiment, transaction market server 3 monitors an amount of power generation of a registered renewable energy facility for a registered facility 7 that has registered a renewable energy facility (facility 7 that uses a renewable energy tag). Transaction market server 3 obtains, from agent 2 of facility 7, a reported value indicating the amount of power generation of the registered renewable energy facility for each unit time slot. Transaction market server 3 then predicts the amount of power generation of a registered renewable energy facility from the meteorological information on the area including the location of facility 7 and the power generation capacity of this renewable energy facility Transaction market server 3 then compares the predicted amount of power generation with the reported value of the renewable energy facility, and when the discrepancy therebetween is not less than the first threshold, prohibits facility 7 with this renewable energy facility from using the renewable energy tag. Thus, transaction market server 3 does not accept a bid with the renewable energy tag attached to the electric power from the relevant facility 7 (agent 2). This can suppress a fraud of reporting electric power that is not generated using renewable energy (non-renewable energy power) as renewable energy power

For facility 7 that has been prohibited from using the renewable energy tag, the administrator of transaction market server 3 (e.g.. an employee of a management company) checks the renewable energy facility in facility 7 on site. When the administrator of transaction market server 3 checks that no fraud has been conducted on the registered renewable energy facility of the relevant facility 7, facility 7 that has been prohibited from using the renewable energy tag can use the renewable energy tag again. For example, an abnormality of the reported value may be detected due to a temporal malfunction of a renewable energy facility and/or rapid weather changes. In such a case, the use of the renewable energy tag is enabled again by checking a renewable energy facility on site, thus suppressing unreasonable prohibition on the use of a renewable energy tag

### Variation 1

The embodiment has described an example in which a fraudulent use of a renewable energy tag is detected using a predicted amount of power generation. Variation 1 will describe an example in which a fraudulent use of a renewable energy tag is detected by another technique.

Variation 1 will describe the technique of comparing the ratio between a reported value and a power generation capacity with the ratio of another facility 7 located in the same area to detect a fraudulent use of a renewable energy tag. It is assumed here that the reported value of PV 8A has been received from the agent (business agent) 2 of factory 7A.

Upon receipt of the reported value from agent 2, transaction market server 3 reads a power generation capacity of PV 8A (i.e., a power generation capacity of the renewable energy facility corresponding to the reported value) from memory 32. Transaction market server 3 then calculates a ratio (hereinafter also referred to as “ratio value A”) between the reported value and the power generation capacity. Transaction market server 3 stores this ratio value in memory 32.

A ratio value B. which is calculated using the reported value received from agent 2 of facility 7 (here, company 7B by way of example), is stored in memory 32 of transaction market server 3. This facility 7 is located in the same area, and has a renewable energy facility of the same power generation type, as those of factory 7A. The reported value used in the calculation of ratio value B is a reported value received in the same time slot as that of the reported value for calculating ratio value A described above. Ratio value B is a ratio between the reported value from agent 2 of company 7B and the power generation capacity of the renewable energy facility (PV 8B) of company 7B. Transaction market server 3 reads ratio value B from memory 32.

The same area may be, for example, an area to which the same prediction is applied in weather forecasting. Alternatively, the same area may be on a municipal basis

Transaction market server 3 compares ratio value A with ratio value B, and when the discrepancy between the values is within a second threshold, determines that the renewable energy tag is being used without fraud in factory 7A. On the other hand, when the discrepancy between the values is not less than the second threshold, transaction market server 3 determines that the renewable energy tag is possibly being used fraudulently in factory 7A, and prohibits factory 7A from using the renewable energy tag. In other words, even when factory 7A makes a bid with a renewable energy tag attached to electric power, transaction market server 3 does not accept this bid.

The second threshold can be determined in consideration of, for example, an error in weather (e.g., an error in the amount of sunlight or an error in the velocity of the wind), an error in computation, or the like.

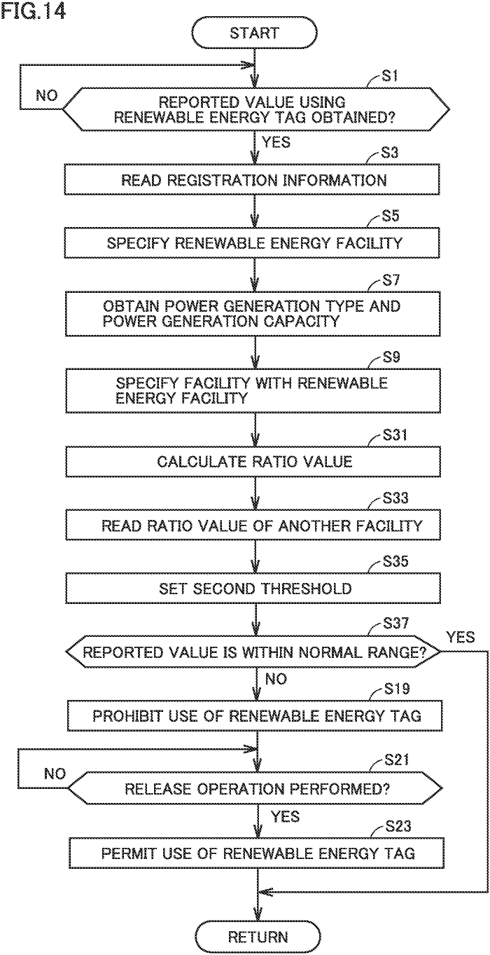

FIG. 14 is a flowchart showing a procedure of a process regarding whether a renewable energy tag can be used according to Variation 1. The flowchart shown in FIG. 14 is obtained by deleting S11 to S17 and adding S31 to S37 from and to the flowchart of FIG. 13. Any other processing of the flowchart of FIG. 14 is similar to processing of the flowchart of FIG. 13, which is denoted by the same step number and will not be repeatedly described.

In S31, processor 31 calculates ratio value A using the reported value and the power generation capacity of the renewable energy facility read in S7.

In S33, processor 31 reads, from memory 32, a ratio value B of another facility 7 that is in the same area, and has a renewable energy facility of the same power generation type, as those of facility 7 specified in S9.

In S35, processor 31 sets a second threshold (a lower limit and an upper limit) for comparing a difference value between ratio value A and ratio value B

In S37, processor 31 determines whether a discrepancy between ratio value A and ratio value B is within the second threshold, that is, whether the reported value is within the normal range. When the discrepancy between ratio value A and ratio value B is within the second threshold, that is, when the reported value is within the normal range (YES in S37), processor 31 determines that the renewable energy facility will be used legitimately, and moves the process to RETURN. When the discrepancy between ratio value A and ratio value B is not within the second threshold, that is, when the reported value is outside the normal range (NO in S37), processor 31 moves the process to S19.

As described above, a fraudulent use of a renewable energy tag can be detected appropriately also by comparing the ratio between the reported value and the power generation capacity with the ratio between the reported value and the power generation capacity which is reported from another facility 7 in the same area and in the same time slot. The other facility 7 has a renewable energy facility of the same power generation type as that of the renewable energy facility of a target facility. 7.

### Variation 2

Variation 2 will describe an example in which a fraudulent use of a renewable energy tag is detected by another technique. Variation 2 will describe an example in which a fraudulent use of a renewable energy tag is detected using the combination of the past reported value of the relevant facility 7 and meteorological information 37 at that time. It is assumed here that the reported value of PV SA has been received from agent (business agent) 2 of factory 7A.

Upon receipt of the reported value from agent 2, transaction market server 3 reads, from memory 32, the reported value reported in the past from the relevant agent 2 and meteorological information 37 at that time which is associated with this reported value Transaction market server 3 predicts an amount of power generation of PV 8A based on the current (at the time of reception of the reported value this time) meteorological information 37 using the read past reported value and meteorological information 37. Transaction market server 3 then compares this predicted value with the reported value, and when the discrepancy between these values is within a third threshold, determines that the renewable energy tag is being used without fraud in factory 7A. On the other hand, when the discrepancy between these values is not less than the third threshold, transaction market server 3 determines that the renewable energy tag is possibly being used fraudulently in factory 7A and prohibits factory 7A from using the renewable energy tag. In other words, even when factory 7A makes a bid with a renewable energy tag attached to electric power, transaction market server 3 does not accept this bid. In the prediction of the amount of power generation of PV 8A, for example, a learned model may be used, which is obtained through machine learning using meteorological information, a power generation capacity, a power generation type, and an actual amount of power generation as training data

The third threshold can be determined based on, for example, a prediction error derived by experiment or simulation.

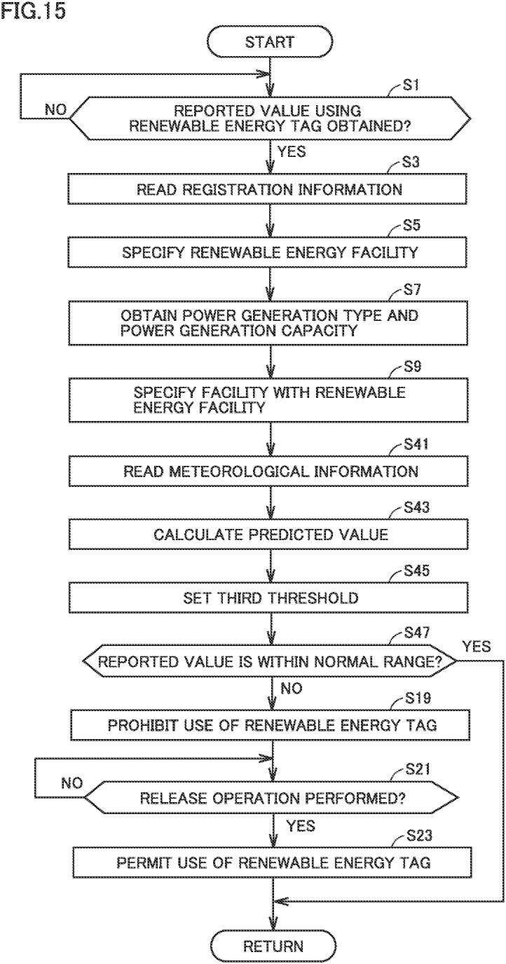

FIG. 15 is a flowchart showing a procedure of a process regarding whether a renewable energy tag can be used according to Variation 2. the flowchart shown in FIG. 15 is obtained by deleting S11 to S17 and adding S41 to S47 from and to the flowchart of FIG. 13. Any other processing of the flowchart of FIG. 15 is similar to processing of the flowchart of FIG. 13, which is denoted by the same step number and will not be repeatedly described.

In S41, processor 31 reads the reported value reported in the past from agent 2 of facility 7 specified in S9 and meteorological information 37 at the time which is associated with this reported value

In S43, processor 31 calculates a predicted value (predicted amount of power generation) of the amount of power generation of a renewable energy facility based on the current (at the time of reception of the reported value this time) meteorological information 37 using the past reported value and meteorological information 37 read in S41.

In S45, processor 31 sets a third threshold (a lower limit and an upper limit) for comparing the predicted value with the reported value

In S47, processor 31 determines whether a discrepancy between the predicted value and the reported value is within the third threshold, that is, whether the reported value is within the normal range When the discrepancy between the predicted value and the reported value is within the third threshold, that is, when the reported value is within the normal range (YES in S47), processor 31 determines that the renewable energy facility will be used legitimately and moves the process to RETURN. When the discrepancy between the predicted value and the reported value is not within the third threshold, that is, when the reported value is outside the normal range (NO in S47), processor 31 moves the process to S19.

As described above, a fraudulent use of a renewable energy tag can be detected appropriately also by comparing the reported value with the amount of power generation predicted from the past reported value and meteorological information 37 associated therewith.

### Variation 3

Variation 3 will further describe an example in which a fraudulent use of a renewable energy tag is detected by another technique in Variation 3, a temporal transition of a reported value is compared with a temporal power generation trend of a renewable energy facility corresponding to this reported value, thereby detecting a fraudulent use of a renewable energy tag. It is assumed here that the reported value of PV 8A has been received from agent (business agent) 2 of factory 7A.

Upon receipt of the reported value from agent 2, transaction market server 3 reads information indicating the power generation trend of PV 8A from memory 32. The information indicating the power generation trend is information indicating an experimental result using the same device type as that of PV 8A or an amount of power generation by time slot of day which is derived from the specifications. The information indicating a power generation trend may be prepared for each weather and each season. Transaction market server 3 may detect a fraud of a renewable energy tag based on an approximate value between a graph and information indicating a power generation trend The graph shows a temporal change in the amount of power generation derived from the history of the reported values in the day (a day when the reported value this time is received) and the reported value this time.

When the approximate value is within a fourth threshold, transaction market server 3 determines that the renewable energy tag is being used without fraud in factory 7A. On the other hand, when the approximate value is not less than the fourth threshold, transaction market server 3 determines that the renewable energy tag is possibly being used fraudulently in factory 7A and prohibits factory 7A from using the renewable energy tag In other words, even when factory 7A makes a bid with a renewable energy tag attached to electric power, transaction market server 3 does not accept this bid. Various known approximation algorithms are applicable to the calculation of an approximate value.

The fourth threshold can be determined, for example, according to a degree of subdivision of weather and season that provides information indicating a power generation trend

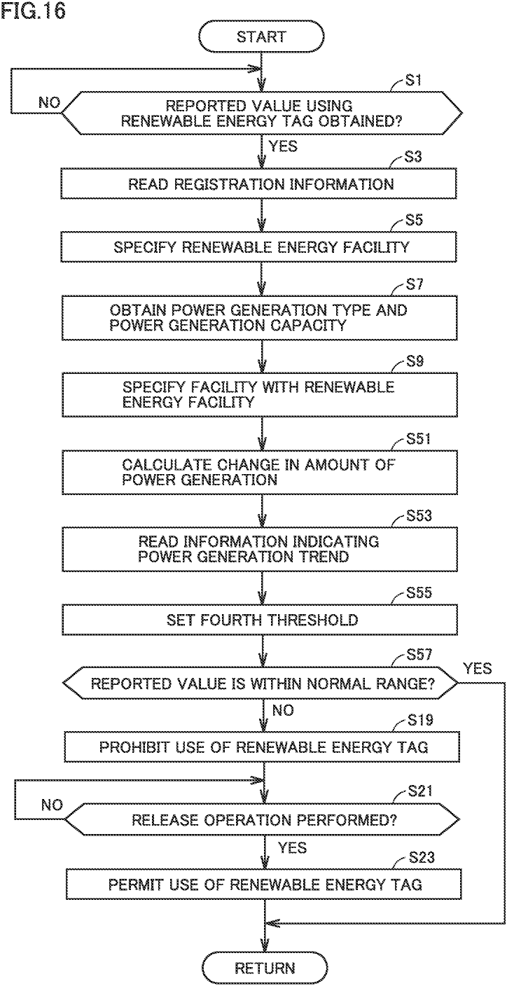

FIG. 16 is a flowchart showing a procedure of a process regarding whether a renewable energy tag can be used according to Variation 3. The flowchart shown in FIG. 16 is obtained by deleting S11 to S17 and adding S51 to S57 from and to the flowchart of FIG. 13. Any other processing of the flowchart of FIG. 16 is similar to processing of the flowchart of FIG. 13, which is denoted by the same step number and will not be repeatedly described

In S51, processor 31 calculates a temporal change in the amount of power generation which is derived from the history of reported values of today and a reported value this time of the renewable energy facility specified in S5.

In S53, processor 31 reads, from memory 32, information indicating a power generation trend of the renewable energy facility specified in S5.

In S55, processor 31 sets the fourth threshold (a lower limit and an upper limit) for comparing the temporal change in the amount of power generation calculated in S51 with the information indicating a power generation trend.

In S57, processor 31 determines whether the approximate value between a temporal change in the amount of power generation and the information indicating a power generation trend is within the fourth threshold, that is, whether the reported value this time is within the normal range. When the approximate value is within the fourth threshold, that is, when the reported value is within the normal range (YES in S57), processor 31 determines that the renewable energy facility will be used legitimately and moves the process to RETURN. When the approximate value is not within the fourth threshold, that is, when the reported value this time is outside the normal range (NO in S57), processor 31 moves the process to S19.

As described above, a fraudulent use of a renewable energy tag can be detected appropriately also by comparing a temporal change in the reported value with a temporal power generation trend of a renewable energy facility corresponding to the reported value.

### Variation 4

In the embodiment and Variations 1 to 3, the reported value is transmitted to transaction market server 3 via agent 2 of facility 7 with PV 8. However, the transmission of a reported value to transaction market server 3 is not limited to the transmission via agent 2 For example, a smart meter may be provided between facility 7 and power transmission line network PL and between facility 7 and charging and discharging facility 6, and a reported value may be transmitted from the smart meter to transaction market server 3.

The above configuration can also achieve the effects similar to those of the embodiment and Variations 1 to 3.

Although the present disclosure has been described and illustrated in detail, it is dearly understood that the same is by way of illustration and example only and is not to be taken by way of limitation, the scope of the present disclosure being interpreted by the terms of the appended claims.

What is claimed is:

1. A server that manages a power transaction market in which a first prosumer performs a power transaction,
the first prosumer including a first power generation facility that generates electric power using renewable energy,
the server comprising:
a memory that stores the first power generation facility registered with the power transaction market, and
a processor that allows the first prosumer to bid for the power transaction market with a tag attached to the electric power generated by the first power generation facility, the tag indicating the electric power generated using the renewable energy,
wherein the processor
monitors a first power generation result indicating an amount of power generation of the first power generation facility in a prescribed time slot, and
upon detection of an abnormality of the first power generation result, does not accept a bid for the power transaction market from the first prosumer with the tag attached to the electric power generated by the first power generation facility.

2. The server according to claim 1, wherein
the memory stores meteorological information and a first power generation capacity of the first power generation facility,
the processor
calculates a predicted amount of power generation of the first power generation facility based on the meteorological information and the first power generation capacity, and
when a discrepancy between the first power generation result and the predicted amount of power generation is not less than a first threshold, detects the abnormality.

3. The server according to claim 1, wherein
the memory stores a first power generation capacity of the first power generation facility, a second power generation capacity of a second power generation facility of a second prosumer that participates in the power transaction market, and a second power generation result indicating an amount of power generation of the second power generation facility in the prescribed time slot, the second power generation facility generating electric power using renewable energy,
the second power generation facility is installed in a same area as that of the first power generation facility, and
the processor detects the abnormality when a discrepancy between a first ratio and a second ratio is not less than a second threshold, the first ratio being a ratio between the first power generation result and the first power generation capacity, the second ratio being a ratio between the second power generation result and the second power generation capacity.

4. The server according to claim 1, wherein
the memory stores a past power generation result of the first power generation facility together with meteorological information associated with the past power generation result, and
the processor
calculates a predicted amount of power generation of the first power generation facility in the prescribed time slot from the past power generation result and the meteorological information, and
detects the abnormality when a discrepancy between the first power generation result and the predicted amount of power generation is not less than a third threshold.

5. The server according to claim 1, wherein
the memory stores information indicating a power generation trend of the first power generation facility, and
the processor detects the abnormality when an approximate value between a change in an amount of power generation of the first power generation facility and the information indicating the power generation trend is not less than a fourth threshold, the change being derived from a power generation result and the first power generation result, the power generation result indicating an amount of power generation of the first power generation facility in a time slot prior to the prescribed time slot.

6. The server according to claim 1, wherein upon detection of the abnormality of the first power generation result and upon receipt of a command to lift prohibition art use of the tag, the processor accepts, from the first prosumer, a bid for the power transaction market with the tag attached to the electric power generated by the first power generation facility.

7. A power transaction system comprising
a server that manages a power transaction market; and
a prosumer that participates in the power transaction market, wherein
the prosumer includes a power generation facility that generates electric power using renewable energy,
the server
stores the power generation facility registered with the power transaction market, and
allows the prosumer to bid for the power transaction market with a tag attached to the electric power generated by the power generation facility, the tag indicating the electric power generated using the renewable energy, and
the server
monitors a power generation result indicating an amount of power generation of the power generation facility in a prescribed time slot, and
upon detection of an abnormality of the power generation result, does not accept a bid for the power transaction market from the prosumer with the tag attached to the electric power generated by the power generation facility.
